(19) United States
(12) Patent Application Publication
(10) Pub. No.: US 2018/0311600 A1
(43) Pub. Date: Nov. 1, 2018

(54) ACTIVATED CARBON FIBER FILTER MEDIA LAMINATE

(71) Applicant: Brita LP, Oakland, CA (US)

(72) Inventors: Nikhil P. Dani, Pleasanton, CA (US); Russell Bell, Pleasanton, CA (US)

(21) Appl. No.: 15/756,713

(22) PCT Filed: Sep. 27, 2016
(86) PCT No.: PCT/IB2016/001472

§ 371 Date: Mar. 1, 2018

Related U.S. Application Data
(60) Provisional application No. 62/235,289, filed on Sep. 30, 2015.

(51) Int. Cl. B01D 39/20; B01D 39/16; B32B 3/04; B32B 5/02; B32B 5/26; B32B 37/12; B32B 37/18; B32B 38/00; B32B 7/12; D04H 1/407; D04H 1/4242; D04H 1/58

(52) U.S. Cl. CPC B01D 39/2065; D10B 2101/12; B32B 3/04; B32B 5/022; B32B 5/26; B32B 37/1207; B32B 37/185; B32B 38/0004; B32B 7/12; D04H 1/407; D04H 1/4242; D04H 1/58; B01D 2239/0208; B01D 2239/0618; B01D 2239/0681; B01D 2239/10; B32B 2037/1215; B32B 2250/03; B32B 2250/20; B32B 2250/40; B32B 2262/0276; B32B 2262/106; B32B 2305/20; B32B 2307/726; B32B 2313/04; B32B 2367/00; D10B 2505/04; B01D 39/163

(57) ABSTRACT

In one example, a filter media laminate is provided that includes a first non-woven layer, a second non-woven layer, and an activated carbon fiber (ACF) layer disposed between, and attached to, the first non-woven layer and the second non-woven layer such that the ACF layer, the first non-woven layer, and the second non-woven layer collectively form the laminate.

### CROSS-REFERENCE TO RELATED APPLICATIONS

This application is the National Stage of International Application No. PCT/IB2016/001472, filed Sep. 27, 2016, which claims the benefit under 35 U.S.C. 119(e) of U.S. Provisional Application No. 62/235,289, filed Sep. 30, 2015. The disclosure of each of the above applications is incorporated by reference in its entirety. This application is also related to the following United States patent applications: U.S. patent application Ser. No. 15/______,______ (Docket 482.556A), entitled FILTER CORE CONFIGURATION, which is the National Stage of International Application No. PCT/IB2016/001495, filed Sep. 27, 2016, which claims the benefit under 35 U.S.C. 119(e) of U.S. Provisional Application No. 62/235,295, filed Sep. 30, 2015; U.S. patent application Ser. No. 15/______,______ (Docket 482.558A), entitled FILTER DESIGN WITH INTERCHANGEABLE CORE COVER which is the National Stage of International Application No. PCT/IB2016/001479, filed Sep. 27, 2016, which claims the benefit under 35 U.S.C. 119(e) of U.S. Provisional Application No. 62/235,304, filed Sep. 30, 2015; and, U.S. patent application Ser. No. 15/______,______ (Docket 482.560A), entitled FILTER CARTRIDGE PLACEMENT IN FILTER AS YOU POUR SYSTEM which is the National Stage of International Application No. PCT/IB2016/001474, filed Sep. 27, 2016, which claims the benefit under 35 U.S.C. 119(e) of U.S. Provisional Application No. 62/235,321, filed Sep. 30, 2015. All of the aforementioned applications are filed the same day herewith, and are incorporated herein in their respective entireties by this reference.

### FIELD OF THE INVENTION

Embodiments of the present invention generally concern water filtration systems for pitchers and other fluid containers. More particularly, embodiments of the invention relate to a filter media laminate that includes one or more layers of activated carbon fiber (ACF).

### BACKGROUND

Water filtration has become common in homes, offices and other places to produce cleaner and better tasting water. Accordingly, water containers such as pitchers have been equipped with filtration systems. In some instances, these filtration systems may employ a filter cartridge or other device that filters water at some point prior to dispensation of the water from the container. For example, some filtration systems include a filter cartridge that contains a filter media such as an ion exchange resin (IER), which may be combined in some cases with activated carbon granules. The filter cartridge may include openings that allow unfiltered water to enter the interior of the filter cartridge where the unfiltered water comes into contact with the filter media which then acts to remove contaminants from the water as the water flows through the interior of the filter cartridge. After filtering is completed, the filtered water exits the filter cartridge and the treated is ready to be dispensed from the water pitcher for consumption by a user.

Use of filter media such as IER and activated carbon granules has proven problematic in some respects however. For example, these materials may escape from the filter cartridge and into the water, where they can be seen by the user. This may be disconcerting to the user. Another concern with such filter media is that flow rates through the filter media may be relatively low and, thus, unsatisfactory to the user.

In recognition of problems such these, filtration systems have been devised that include a pliable filter media disposed around a filter core. This approach has proven problematic as well however. For example, while such filter media may be effective in use, they can be relatively fragile and not well suited to withstand the rigors of manufacturing processes, such as attachment to a filter core for example. As well, this type of filter media may be prone to contamination during manufacturing.

In light of problems such as those noted above, it would be useful to provide filter media that is sufficiently durable to withstand the rigors of manufacturing processes, while maintaining filtration effectiveness in the finished product that includes the filter media. As well, it would be useful for the filter media to be configured and constructed in such a way as to reduce the likelihood of contamination of the filter media during manufacturing processes, and use by the end user.

### Aspects of an Example Embodiment

One or more embodiments within the scope of the invention may be effective in overcoming one or more of the disadvantages in the art. One example embodiment is directed to filter media in the form of a laminate that includes a layer of activated carbon fiber (ACF) media positioned between two layers of non-woven material which are arranged so that when the laminate is wrapped around a structure such as a filter core for example, one of the non-woven layers is an inner layer, and the other non-woven layer is an outer layer. As well, each side of the non-woven layers may include an adhesive layer or adhesive material so that the non-woven layers can achieve and maintain substantial contact with the ACF layer, and with each other.

In this example embodiment, the non-woven layers are relatively longer than the ACF layer so that when the non-woven layers are attached to each other, at least two edges of the ACF layer are substantially enclosed by the non-woven layers. This configuration of the non-woven layers also results in the definition of a pair of wings, where each wing includes portions of each non-woven layer that extend beyond the enclosed edges of the ACF layer. The adhesive layers or adhesive material on the non-woven material enable one wing of the laminate to be securely attached to a structure such as a filter core, while the other wing of the laminate can be wrapped around, and attached to, the outer non-woven layer of the laminate.

The foregoing embodiment is provided solely by way of example and is not intended to limit the scope of the invention in any way. Consistently, various other embodiments of filter management elements and associated filters and containers, within the scope of the invention are disclosed herein.

### BRIEF DESCRIPTION OF THE DRAWINGS

In order to describe the manner in which at least some aspects of this disclosure can be obtained, a more particular description will be rendered by reference to specific embodiments thereof which are illustrated in the appended drawings. Understanding that these drawings depict only example embodiments of the invention and are not therefore to be considered to be limiting of its scope, embodiments of the invention will be described and explained with additional specificity and detail through the use of the accompanying drawings, in which:

FIG. 1 is a top view of an example embodiment of a filter media laminate;

FIG. 2 is a lengthwise side/section view of the example filter media laminate of FIG. 1;

FIG. 2a discloses an alternative to the configuration of FIG. 2;

FIG. 3 is an end view of the example filter media laminate of FIG. 1;

FIG. 4 is widthwise section view of the example filter media laminate of FIG. 1;

FIG. 5 is a top view of another example embodiment of a filter media laminate;

FIG. 6 is an end/side view of the example filter media laminate of FIG. 5;

FIG. 7 is a lengthwise section view of the example filter media laminate of FIG. 5;

FIG. 8 is a top view disclosing attachment of a laminate wing to a filter core;

FIG. 9 is a side view disclosing attachment of an outer non-woven layer to an inner non-woven layer; and

FIG. 10 is a flow diagram disclosing aspects of an example production process.

### DETAILED DESCRIPTION OF SOME EXAMPLE EMBODIMENTS

Reference will now be made in detail to aspects of various embodiments of the present disclosure, examples of which are illustrated in the accompanying drawings. While described in conjunction with these embodiments, it will be understood that they are not intended to limit the disclosure to these embodiments.

In general, embodiments of the invention can be employed in connection with devices, such as fluid containers, where there is a need to filter fluid before the fluid is dispensed from the container. In one particular example, embodiments of the invention can be used in conjunction with a water pitcher, although the scope of the invention is not limited to this example environment and extends, more generally, to any environment where such embodiments can be usefully employed. For example, embodiments of the invention can be employed with any water, or other fluid, container, examples of which include, but are not limited to, water bottles, carafes, and jugs.

A. Example Filter Media Laminate Configuration and Materials

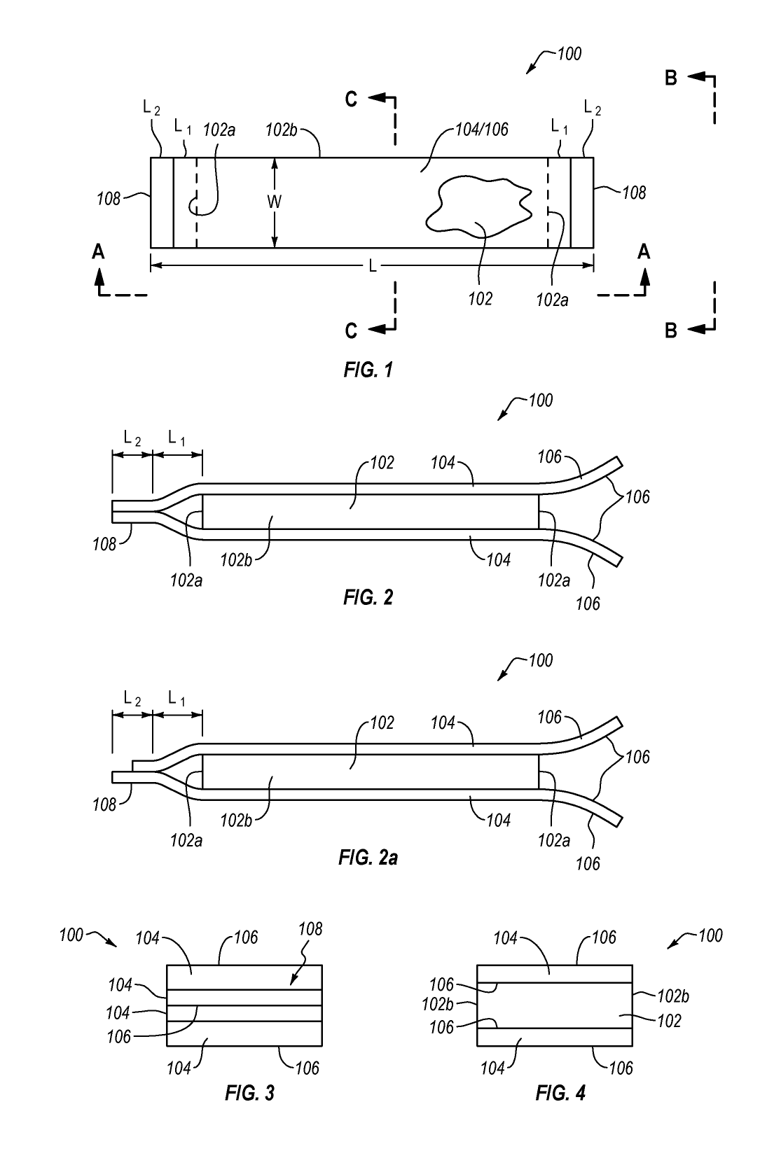

Directing attention now to FIGS. 1-4, details are provided concerning a filter media laminate, one example of which is denoted generally at 100. As indicated, view A-A is a lengthwise side view of the filter media laminate 100 and corresponds to FIG. 2, view B-B is an end view of the filter media laminate 100 and corresponds to FIG. 3, and view C-C is a widthwise section view of the filter media laminate 100 and corresponds to FIG. 4.

In general, the filter media laminate 100 comprises multiple layers that collectively form a stack. In the illustrated embodiment, the filter media laminate 100 includes one, or more, ACF layers 102 positioned between two layers 104. Where multiple ACF layers 102 are employed, the ACF layers 102 can be attached to each other in one or more locations, such as at one or more of the edges of the ACF layers 102 for example. More generally, the ACF layers 102 can be attached to each other in any way that does not materially compromise the performance of the ACF layers 102, such as the flow rate through the ACF layers 102. Each of the layers 104 may comprise, or consist of, a layer of non-woven material. As such, some embodiments of the layers 104 may be referred to herein as ‘non-woven’ layers. In an alternative embodiment, the filter media laminate 100 consists of an ACF layer 102 disposed between a pair of non-woven layers 104, that is, in this alternative embodiment, the filter media laminate 100 consists of a total of three layers, no more and no less.

With continued reference to FIGS. 1-4, the ACF layer 102 may take the form of a non-granular, non-particulate, non-woven, activated carbon fiber (ACF) material. One example of a suitable activated carbon fibrous felt material is available from Kuraray Chemical Co., LTD of Osaka, Japan under the trade name KURACTIVE. Another example of suitable ACF is available from Jiangsu SuTong (JSST) Carbon Fiber Co., Ltd. of China.

In at least some embodiments, the ACF layer 102 may have a thickness in a range from about 0.5 mm to about 2 mm (e.g., in a range of about 0.75 mm to about 1 mm). However, a thickness less than about 0.5 mm (e.g., about 0.1, about 0.25, etc.) or greater than about 2 mm (e.g., about 2.5 mm, about 3 mm, about 4 mm, about 5 mm, about 10 mm, etc.) is also contemplated. Indeed, any of the above numeric values of thickness in units of centimeters, inches, etc. can also be suitable in certain implementations.

The thickness of the ACF layer 102 can be selected based on a variety of considerations. For example, the thickness of the ACF layer 102 can be determined at least in part by a desired flow rate through the ACF layer 102. Thus, the thickness of the ACF layer 102 may be such as to permit a flow rate through the ACF layer 102 in a range of about 0.5 gpm to about 1.5 gpm. In another example, the thickness of the ACF layer 102 may be such as to permit a flow rate through the ACF layer 102 in a range of about 0.6 gpm to about 1.2 gpm. In a final example, the thickness of the ACF layer 102 may be such as to permit a flow rate through the ACF layer 102 in a range of about 0.3 gpm to about 1.0 gpm. One, some, or all, of the aforementioned flow rate ranges can be achieved when the filter media laminate 100 assumes a curved configuration such that water entering and/or leaving the filter media laminate 100 passes through a curved surface of the filter media laminate 100.

Turning now to the layers 104, one or both of the layers 104 may comprise, or consist of, a non-woven material, such as a layer of polyester for example, having first and second opposing surfaces. As well, one or both sides of the layer 104 include an adhesive 106. The adhesive 106 can take any form, such as a coating or a layer, or can be impregnated into the polyester. In one particular embodiment, the adhesive 106 is a heat-activated adhesive, such as a polyethylene (PE) binder that is dispersed evenly on the surfaces of the polyester. The adhesive 106, in this example, has a higher melting point than the melting point of the polyester. As such, the adhesive 106 can be melted without melting or otherwise damaging the polyester material. In an alternative embodiment, the adhesive 106 may be a pressure-activated adhesive.

It should be noted that it is important, when selecting material for the layers 104, that the material not compromise the performance and effectiveness of the ACF layer 102. Thus, the layers 104 should each consist of, or substantially comprise, a material whose permeability is about the same as, or higher than, a permeability of the ACF layer 102. Put another way, the porosity of each of the layers 104 should be about the same as, or higher than, the porosity of the ACF layer 102, and the density of each of the layers 104 should be about the same as, or lower than, the density of the ACF layer 102.

With continued reference to FIGS. 1-4, further details are provided concerning the example filter media laminate 100. As shown in FIGS. 1 and 2 for example, the length of the ACF layer 102 may be relatively shorter than a length of the layers 104. As a result of this configuration, a widthwise extending wing 108 can be formed at each end of the filter media laminate 100. As best shown in FIG. 2, each wing 108 is formed by attaching the layers 104 to each other at a location beyond the widthwise edge 102a of the ACF layer 102. In the particular example of FIG. 2, the wing 108 is formed by coextensive portions of the upper and lower layers 104.

In other embodiments however, and with reference to FIG. 2 as well as FIG. 2a, particularly the left-hand side of FIG. 2a, the wings 108 can alternatively be configured using only one of the upper or lower layers 104. For example, one or both of the wings 108 can be configured such that, for example, the left-hand wing 108 is formed by a piece of one of the layers 104 that extends past the edge of the other layer 104. The extending portion can be part of the upper layer 104 or the lower layer 104. In one particular embodiment, and with continued reference to FIGS. 2 and 2a, the left-hand wing 108 can be configured such that the left-hand wing 108 is formed by a portion of the lower layer 104 that extends beyond the edge of the upper layer 104 instead of terminating at the same location as the upper layer 104 as shown in FIG. 2. Similarly, the right-hand wing (not shown) is formed by a portion of the upper layer 104 that extends beyond the edge of the lower layer 104. These arrangements can also be reversed.

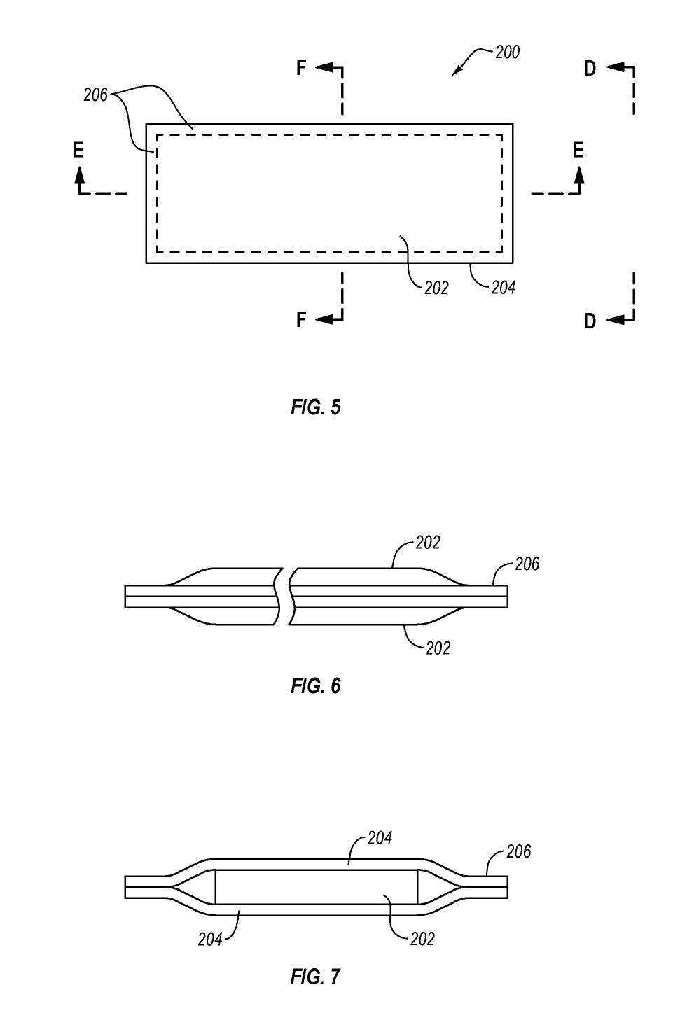

As a result of the attachment of the two layers 104 to each other, the widthwise edges 102a of the ACF layer 102 are substantially, or completely, enclosed by the layers 104. In the example of FIGS. 1-4, the lengthwise edges 102b of the ACF layer 102 are not enclosed by the layers 104. In other embodiments however, such as the embodiment of FIGS. 5-7 for example, all of the edges of the ACF layer 102 may be enclosed by the layers 104. In any case, because the layers 104 may include an adhesive, such as the adhesive 106 discussed elsewhere herein, the layers 104 can be bonded to each other, such as by the application of heat for example. Further details concerning some example production processes are set forth elsewhere herein.

Depending upon the use(s) to which the filter media laminate 100 is to be put, it may be useful to ensure that the wings 108 are of a particular length. As shown in FIGS. 1 and 2, an overall length of the wings 108 may be defined by the sum of a first length L₁ and a second length L₂. The first length L₁ may be sufficient to ensure that the end 102a of the ACF layer 102 will be enclosed when the layers 104 are attached to each other and, as such, the first length L₁ may be referred to herein as a sealing portion of a wing. The second length L₂ may be sufficient to ensure that the size of the wing 108 is adequate to enable the wing 108 to be attached to a structure, such as a filter core for example, and, as such the second length L₂ may be referred to herein as an attachment portion of a wing. Further details in this regard are provided below in connection with the discussion of FIG. 9. As with the other dimensions of the filter media laminate 100, the dimensions of the wings 108 can be selected as necessary. The wings 108 may have the same dimensions as each other, although that is not necessarily required. As well, in one particular embodiment, both the first length L₁ and the second length L₂ are about 10 mm, although larger or smaller dimensions could be used and/or one of the lengths may be different from the other length.

With continuing reference to the size and configuration of the example filter media laminate 100, the dimensions of the filter media laminate 100 may, in general, be selected based upon the intended application or use of the filter media laminate 100. Thus, in one particular example, the ACF layer 102 may have a length of about 220 mm, and an overall width ‘W’ of about 85 mm, although larger, or smaller, lengths and widths can alternatively be used. Because the lengthwise edges 102b of the ACF layer 102 are not enclosed by the layers 104 in this embodiment, the overall width of the ACF layer 102 is the same, or nearly the same, as the overall width of the filter media laminate. In this particular example, the two wings 108 may each have an overall length of about 20 mm, such that the overall length ‘L’ of the filter media laminate 100 is about 260 mm. In some embodiments at least, the overall width ‘W’ may correspond to a dimension of a structure such as a filter core while, in these embodiments, the overall length ‘L’ of the filter media laminate 100 may be sufficient to enable the filter media laminate 100 to be wrapped two, or more, times around a structure such as a filter core.

The ACF layer 102 need not be rectangular in all embodiments. Thus, in one particular embodiment, the ACF layer 102 is generally square in shape. Likewise, some embodiments of the layers 104, and filter media laminate 100, may be generally square. More generally, the filter media laminate 100 and its components can be any shape needed to suit an intended application, where such shapes include, but are not limited to, round, square, rectangular, polygonal, elliptical, or any other shape.

With reference now to FIGS. 5-7, details are provided concerning another embodiment of a filter media laminate, denoted generally at 200. Except as noted in the following discussion, the filter media laminate 200 may be similar, or identical, to the filter media laminate 100. As indicated, view D-D is a widthwise end view of the filter media laminate 200 and corresponds to FIG. 6 (which also indicates a lengthwise side view of the filter media laminate 200), view E-E is a lengthwise section view of the filter media laminate 200 and corresponds to FIG. 2, and view F-F is a widthwise section view of the filter media laminate 200 and corresponds to FIG. 7.

Similar to the filter media laminate 100, the filter media laminate 200 may include an ACF layer 202 disposed between first and second layers 204. As best shown in FIG. 5, and in contrast with the embodiment of FIGS. 1-4, the ACF layer 202 and the layers 204 may be configured and arranged such that the ACF layer 202 is completely enclosed on all sides by the layers 204. As such, the attachment of the layers 204 to each other may result in the definition of a wing 206 that extends about the entire perimeter of the filter media laminate 200.

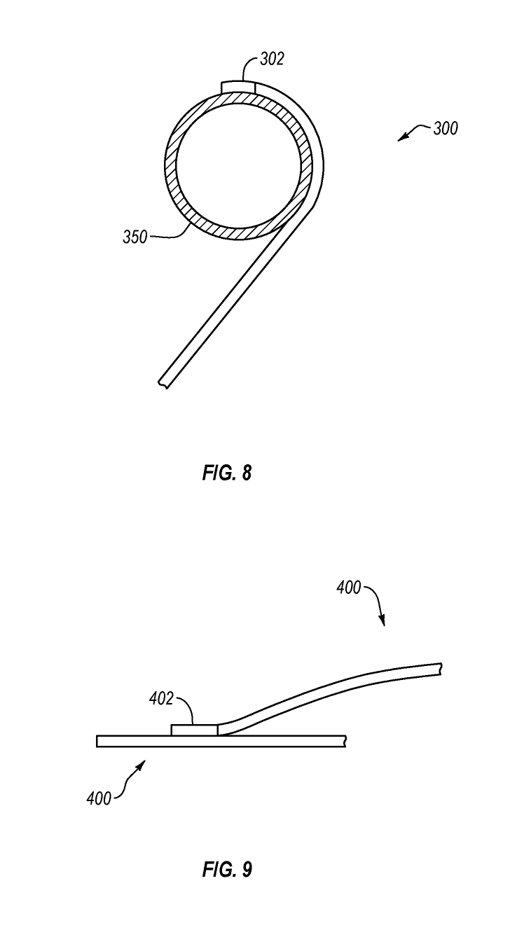

It will be apparent from this disclosure that the structure of the various embodiments of the filter media laminate may provide a number of benefits. For example, and with reference to the example of FIGS. 1-4, the layers 104 of the filter media laminate 100 are relatively durable and thus provide a measure of protection to the ACF layer 102 which may be relatively weak and brittle. The layers 104 also provide structural integrity to the filter media laminate 100. As well, the layers 104 can help to prevent contamination of the ACF layer 102 during manufacturing of a device that includes the filter media laminate 100, such as the filter core discussed in connection with FIG. 8 below. Further, because the permeability of the layers 104 is about the same as, or greater than, the permeability of the ACF layer 102, the layers 104 do not impair the filtering functionality or capability of the ACF layer 102.

Turning now to FIGS. 8 and 9, details are provided concerning some example arrangements involving the attachment of wings to various other elements. It should be noted that the example filter media laminate embodiments 300 and 400 respectively disclosed in FIGS. 8 and 9 may be similar, or identical, to any of the other disclosed embodiments of a filter media laminate. With reference first to the example of FIG. 8, the filter media laminate 300 includes a wing 302 that is, or may be, attached to a hollow filter core 350. In more detail, and as noted elsewhere herein, the wing 302 may include adhesive, such as a heat-activated adhesive for example. Thus, the wing 302 can be securely attached to the hollow filter core 350 by applying heat to the wing 302 and melting the adhesive which then adheres the wing 302 to the hollow filter core 350. This method of attaching the wing 302 to the hollow filter core 350 may be referred to as heat staking. Because the ACF layer (not shown in FIG. 8) is at least partly enclosed by the layers that form the wing 302, the ACF layer does not contact the hollow filter core 350. Moreover, because the wing 302 can be simply attached to the hollow filter core 350, the hollow filter core 350 does not require any special configuration or structure to engage the wing 302.

With reference now to the example of FIG. 9, in the disclosed embodiments, a first portion of a filter media laminate can be attached to a second portion of that filter media laminate by heat staking, or other processes. Thus, in the illustrated example, the filter media laminate 400 includes a wing 402 that can be securely attached to another portion of the filter media laminate 400 by applying heat to the wing 402 and melting the adhesive which then adheres the wing 402 to the other portion of the filter media laminate 400. Because, in some embodiments at least, both the wing 402 and the other portion of the filter media laminate 400 to which the wing 402 is attached include adhesive, the connection between the wing 402 and that other portion may be particularly strong.

B. Aspects of Example Production Processes

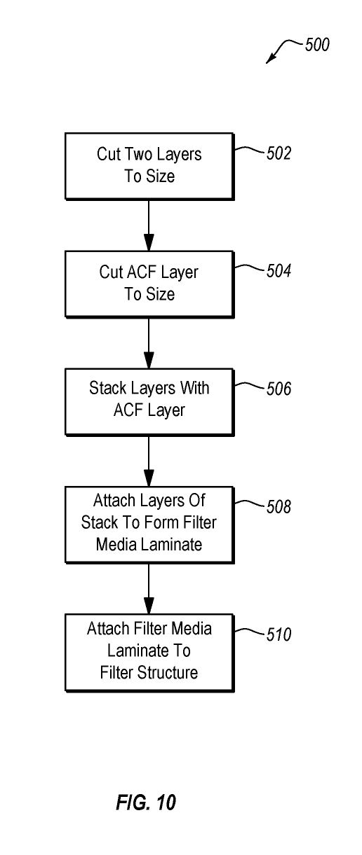

With attention now to FIG. 10, details are provided concerning processes for manufacturing a filter media laminate. One example of such a process is denoted generally at 500. Initially, two layers, which may be non-woven layers, are cut 502 to a size such that when laminated together with an ACF layer, the two non-woven layers define a pair of wings. In at least some embodiments, the non-woven layers can be stacked together and cut to size at the same time. In other embodiments, the non-woven layers can be separately cut. In some embodiments, the same material is used for both of the non-woven layers while, in other embodiments, different respective materials are used for the non-woven layers.

Next, the ACF layer is cut 504. In other embodiments, the ACF layer(s) can be cut before the non-woven layers, or at the same time as the non-woven layers. In general, the ACF layer can be cut to a size such that, when laminated together with the non-woven layers, the non-woven layers extend beyond at least two edges of the ACF layers, such that at least first and second wings are defined by the non-woven layers. Each of the wings may include a sealing portion and an attachment portion. Thus, in at least some embodiments, a length of the ACF layer is shorter than the length of the two non-woven layers. In other embodiments, the length and the width of the ACF layer are shorter than, respectively, the length and width of the non-woven layers.

Once the non-woven layers and ACF layer have been cut, or otherwise processed, to the desired size, the non-woven layers and ACF layers are stacked 506 together to form the structure of the filter media laminate. In particular, the ACF layer is placed between the two non-woven layers and positioned relative to the non-woven layers so that first and second wings of substantially the same size extend beyond respective first and second edges of the ACF layer. After the non-woven layers and the ACF layer have been positioned relative to each other, they can be held together, or otherwise restrained, in preparation for the next stage of the process 500.

After the non-woven layers and the ACF layer have been stacked and positioned, the non-woven layers are then attached 508 to each other and to the ACF layer. In some embodiments, the attachment process 508 is performed by heating the layer stack so as to activate an adhesive that is present on each side of the non-woven layers. In this way, the two layers are attached to each other at the wings, and the two layers are also attached to the ACF layer. The two non-woven layers may have adhesive distributed over a substantial portion, or all, of each of their two sides, that is, the side contacting the ACF layer and the side facing away from the ACF layer. Thus, when the stack is heated, most, or all, of the ACF layer becomes securely attached to both of the non-woven layers.

This secure attachment of the ACF layer to the non-woven layers lends structural integrity to the filter media laminate as a whole, and also prevents the ACF layer from folding or bunching between the two non-woven layers, thereby maintaining the filtering effectiveness of the ACF layer. As well, the secure attachment of the non-woven layers to the ACF layer helps to ensure that the ACF layer will assume whatever shape the filter media laminate is configured to assume. For example, if the filter media laminate is wrapped around a cylindrical filter core, the ACF layer will assume the same wrapped configuration.

Finally, the completed filter media laminate can be attached 510 to a filter structure, such as a filter core for example. Further details concerning such a process, and resulting filter configuration, are set forth in one or more of the ‘Related Applications’ referred to herein. In general however, in some embodiments, one of the wings of the filter media laminate can be heat staked to a filter core, and the free end of the filter media laminate wrapped around the filter core two or more times. Because the ACF layer is positioned between the two non-woven layers, there is little or no contact between the ACF layer and the filter core. When the filter media laminate has been completely wrapped, the wing on the free end can then be attached to the outer non-woven layer. In those embodiments where the wing and/or outer non-woven layer include an adhesive, this attachment process can be effected by heating the wing and the portion of the outer non-woven layer that is located proximate the wing.

The present invention may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed:

1. A filter medium, comprising:
a first non-woven layer;
a second non-woven layer; and
an ACF layer disposed between, and attached to, the first non-woven layer and the second non-woven layer such that the ACF layer, the first non-woven layer, and the second non-woven layer collectively form a laminate.

2. The filter medium as recited in claim 1, wherein one of the non-woven layers has a permeability that is about the same as, or greater than, a permeability of the ACF layer.

3. The filter medium as recited in claim 1, wherein one of the non-woven layers has first and second sides, and one of the first and second sides has an adhesive disposed thereon.

4. The filter medium as recited in claim 3, wherein the adhesive is a heat-activated adhesive.

5. The filter medium as recited in claim 3, wherein the adhesive is a dispersed polyethylene binder.

6. The filter medium as recited in claim 3, wherein the first non-woven layer has a length that is greater than a length of the second non-woven layer.

7. The filter medium as recited in claim 3, wherein the adhesive has a melting point that is lower than a melting point of the non-woven layer.

8. The filter medium as recited in claim 1, wherein one of the non-woven layers substantially comprises polyester.

9. The filter medium as recited in claim 1, wherein the first non-woven layer and the second non-woven layer cooperatively define first and second wings, each of the wings being disposed proximate a respective edge of the ACF layer.

10. A filter medium, comprising:
a first non-woven layer having first and second sides and substantially comprising polyester and including an adhesive on the first and second sides;
a second non-woven layer having first and second sides and substantially comprising polyester and including an adhesive on the first and second sides of the second non-woven layer;
an ACF layer disposed between, and attached to, the first non-woven layer and the second non-woven layer such that the ACF layer, the first non-woven layer, and the second non-woven layer collectively form a laminate,
wherein the first non-woven layer and the second non-woven layer cooperatively define first and second wings, each of the wings being disposed proximate a respective edge of the ACF layer.

11. The filter medium as recited in claim 10, wherein both of the non-woven layers have a permeability that is about the same as, or greater than, a permeability of the ACF layer.

12. The filter medium as recited in claim 10, wherein the adhesive is a heat-activated adhesive.

13. The filter medium as recited in claim 10, wherein the adhesive is a dispersed polyethylene binder.

14. The filter medium as recited in claim 10, wherein the adhesive has a melting point that is lower than a melting point of the non-woven layer.

15. The filter medium as recited in claim 10, wherein two or more edges of the ACF layer are enclosed by the first non-woven layer and the second non-woven layer.

16. A method for manufacturing a filter medium, comprising:
cutting a first non-woven layer to a size;
cutting a second non-woven layer to about the same size as the first non-woven layer;
cutting an ACF layer to a size that is smaller in one dimension than the size of the first non-woven layer and the size of the second non-woven layer;
positioning the ACF layer between the first non-woven layer and the second non-woven layer to form a stack; and
attaching the first non-woven layer and the second non-woven layer to the ACF layer.

17. The method as recited in claim 16, wherein the first non-woven layer and the second non-woven layer are about the same length as each other, and wherein the first non-woven layer and the second non-woven layer are relatively longer than the ACF layer.

18. The method as recited in claim 16, wherein positioning of the ACF layer between the first non-woven layer and the second non-woven layer results in the definition of a pair of wings, each of the wings including a portion of the first non-woven layer and a portion of the second non-woven layer.

19. The method as recited in claim 16, wherein attaching the first non-woven layer and the second non-woven layer to the ACF layer comprises heating the stack so as to melt an adhesive that is present on the first non-woven layer and the second non-woven layer.

20. The method as recited in claim 19, wherein the first non-woven layer and the second non-woven layer each substantially comprise polyester and each include an adhesive comprising a dispersed polyethylene binder.
